(19) United States
(12) Patent Application Publication
(10) Pub. No.: US 2015/0055078 A1
(43) Pub. Date: Feb. 26, 2015

(54) VARIABLE BEAM EXPANDER

(71) Applicant: Thorlabs, Inc., Newtonn, NJ (US)

(72) Inventors: Ross Johnstone, Ashburn, VA (US); Paulo Chaves, Manassas, VA (US); Eric Lieser, Boyce, VA (US); Jeffrey S. Brooker, Oak Hill, VA (US)

(21) Appl. No.: 14/466,341

(22) Filed: Aug. 22, 2014

Related U.S. Application Data
(60) Provisional application No. 61/868,909, filed on Aug. 22, 2013.

(51) Int. Cl. G02B 3/00; G02B 7/00; G02B 19/00; G02B 3/14

(52) U.S. Cl. CPC G02B 3/0081; G02B 3/14; G02B 7/008; G02B 19/0028
USPC 349/200; 359/676; 359/666

(57) ABSTRACT

A variable beam expander, including: a first lens having a first focal length that is adjustable by a control circuit; a second lens having a second focal length that is adjustable by the control circuit; wherein the first lens and the second lens are separated by a fixed distance; and wherein the control circuit is configured to adjust the first and second focal lengths such that the sum of the first and second focal lengths is equal to the fixed distance.

### CROSS REFERENCES TO RELATED APPLICATIONS

This application claims the benefit of U.S. Provisional Patent Application No. 61/868,909 filed on Aug. 22, 2013, currently pending. The disclosure of U.S. Provisional Patent Application 61/868,909 is hereby incorporated by reference.

### FIELD OF THE INVENTION

The invention generally relates to a beam expander, and more particularly to a variable beam expander where the output beam size can be electrically controlled.

### BACKGROUND

A light or laser beam expander is an apparatus that allows parallel light or lasers to have an input beam size expanded to become a larger output beam size. Beam expanders are commonly used to reduce divergence. Another common use is to expand the beam and then focus with another lens to take advantage of a reduction in spot size. Beam expanders are used in many scientific and engineering applications that use their output beams for measurements. Their beam magnification, without affecting chromatics and purposely avoiding focus, allows applications from the smallest, as in microscopes, to the largest of astronomy measurements.

In many applications, there is a need to adjust the beam size or the expansion ratio. There exist variable beam expanders whose desired expansion ratio is typically achieved via rotation, and fixed beam expanders with a sliding collimation adjustment mechanism. However, these beam size or expansion ratio adjustments involve mechanical movements that result in slow, bulky and cumbersome systems.

Beam expanders based on rotation are also susceptible to poor pointing error due to the finite centration of the optical axis of the lenses with respect to the optical axis of the system as a whole. Using liquid lenses helps to reduce this error.

Therefore, there is a need for a variable beam expander that is compact and does not require the rotation or sliding movement to achieve a faster and more convenient beam expansion operation. Furthermore, conventional beam expanders require manual correction to reduce divergence or convergence of the beam, therefore, there is also a need for a device that performs this correction automatically.

### SUMMARY

An embodiment of the invention provides a variable beam expander including a first lens having a first focal length that is adjustable by a control circuit, and a second lens having a second focal length that is adjustable by the control circuit, wherein the first lens and the second lens are separated by a fixed distance and wherein the control circuit is configured to adjust the first and second focal lengths such that the sum of the first and second focal lengths is equal to the fixed distance.

Another embodiment of the invention provides a variable beam expander, including: a first lens having a first focal length that is adjustable by a control circuit, the optical axis of the first lens being in a first vertical direction; a second lens having a second focal length that is adjustable by the control circuit, the optical axis of the second lens being in a second vertical direction; a first mirror; a second mirror; a third mirror; and a fourth mirror; wherein the first mirror is configured to direct a beam coming from an input of the variable beam expander to pass through the first lens in the first vertical direction; wherein the second mirror is configured to direct the beam that passes through the first lens to the third mirror; wherein the third mirror is configured to direct the beam from the second mirror to pass through the second lens in the second vertical direction; wherein the fourth mirror is configured to direct the beam that passes through the second lens to an output of the variable beam expander; and wherein the control circuit is configured to adjust the first and second focal lengths such that the sum of the first and second focal lengths is equal to the sum of the paths from the first lens to the second mirror, from the second mirror to the third mirror, and from the third mirror to the second lens.

Another embodiment of the invention provides a method of operating a variable beam expander that includes a first lens having a first focal length that is adjustable by a control circuit; a second lens having a second focal length that is adjustable by the control circuit; wherein the first lens and the second lens are separated by a fixed distance, the method including: adjusting the first and second focal lengths by the control circuit such that the sum of the first and second focal lengths is equal to the fixed distance.

### BRIEF DESCRIPTION OF THE DRAWINGS

FIG. 1 illustrates the principle of a beam expander.

FIG. 2 illustrates a variable beam expander in accordance with an embodiment of the invention.

FIG. 3 illustrates a variable beam expander in accordance with an embodiment of the invention.

FIG. 4 illustrates how the beam size changes with respect to the location of the focal point in accordance with an embodiment of the invention.

FIG. 5 shows the beam radius as a function of distance from the exit aperture of the device due to diffraction.

FIG. 6 shows the beam radius as a function of distance from the exit aperture of the device with optimization according to an embodiment.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

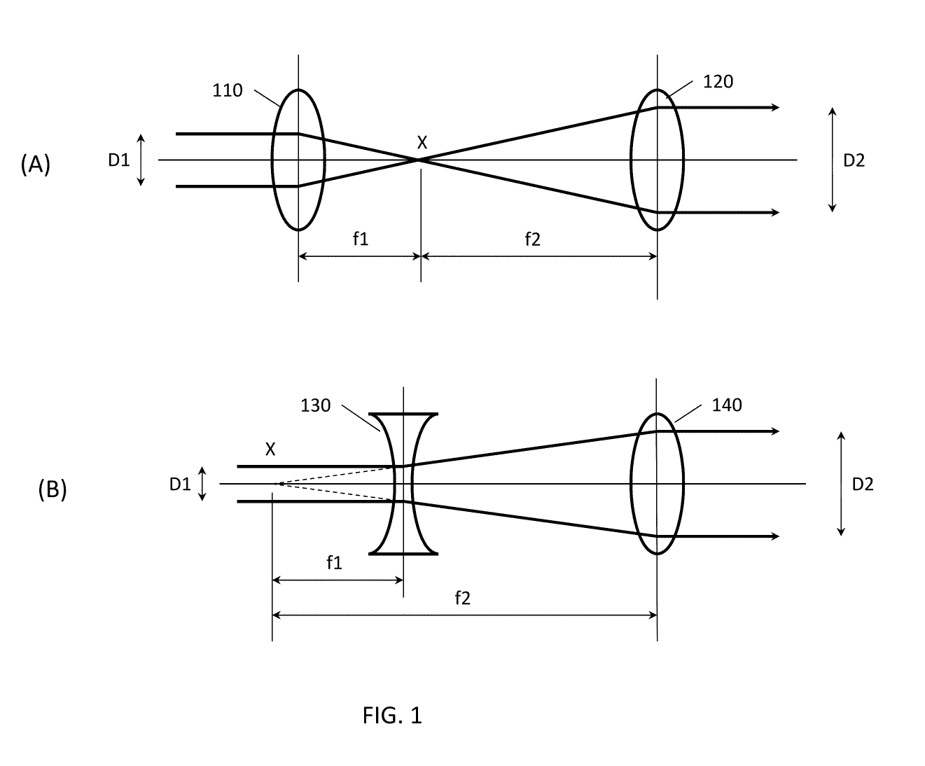

Beam expanders are optical lens assemblies that are used to increase the diameter of a laser beam or other light beam. There are typically two common beam expander types, namely Kepler and Galileo. FIG. 1 (A) shows a Kepler beam expander or Keplerian beam expander that has two positive lenses 110, 120 or groups of lenses. A parallel beam having a beam size D1 enters the lens 110 and focuses on the focal point X at a distance f1 from the lens 110. The point X is also a focal point of lens 120 and is at a distance f2 from the lens 120. The beam emerges from the lens 120 with a beam size of D2. The ratio of D2/D1 is referred to as the expander power M. It can be shown by simple geometry that M=D2/D1=f2/f1.

FIG. 1 (B) shows a Galileo beam expander or Galilean beam expander that has both a negative lens 130 and a positive lens 140, or lens systems. In this case, the point X is a virtual focal point, i.e., the light beam is not physically brought into focus.

In the Kepler-type arrangement, the intermediate focus produces high-grade reference wave fonts with a homogenous intensity. Consequently, Kepler laser beam expanders are used in interferometry and other applications that require an intermediate focal point with a pinhole for spatial filtering. Galileo laser beam expanders do not have an internal focal point and are usually shorter in length. They produce very high levels of energy at the focal point and are used in lasers for material processing applications.

Both Keplerian beam expanders and Galilean beam expanders provide a magnification type known as expander power M. After this power increases the beam diameter in size, the beam divergence is then reduced by this same power. The combination produces a light beam or laser beam that is both larger in size and highly collimated. Typically, beam divergence specifications are given for the full angular spread of the beam. Although these beams are smaller over larger distances, additional focusing options can be used to yield even smaller spot sizes.

As discussed above, existing variable beam expanders involves mechanical movements that makes the system slow, bulky and cumbersome. A better solution would be an electrically tunable system with no mechanically moving optical parts. Realizing such a system requires optical elements with electrically tunable focal lengths and with the capability to adjust the values of f1 and f2 while maintaining the relationship f1+f2=L, where L is the distance between the lenses. Maintaining the distance between the lenses during the expander power M adjustment according to an embodiment of the invention eliminates the mechanical movements that existing systems require.

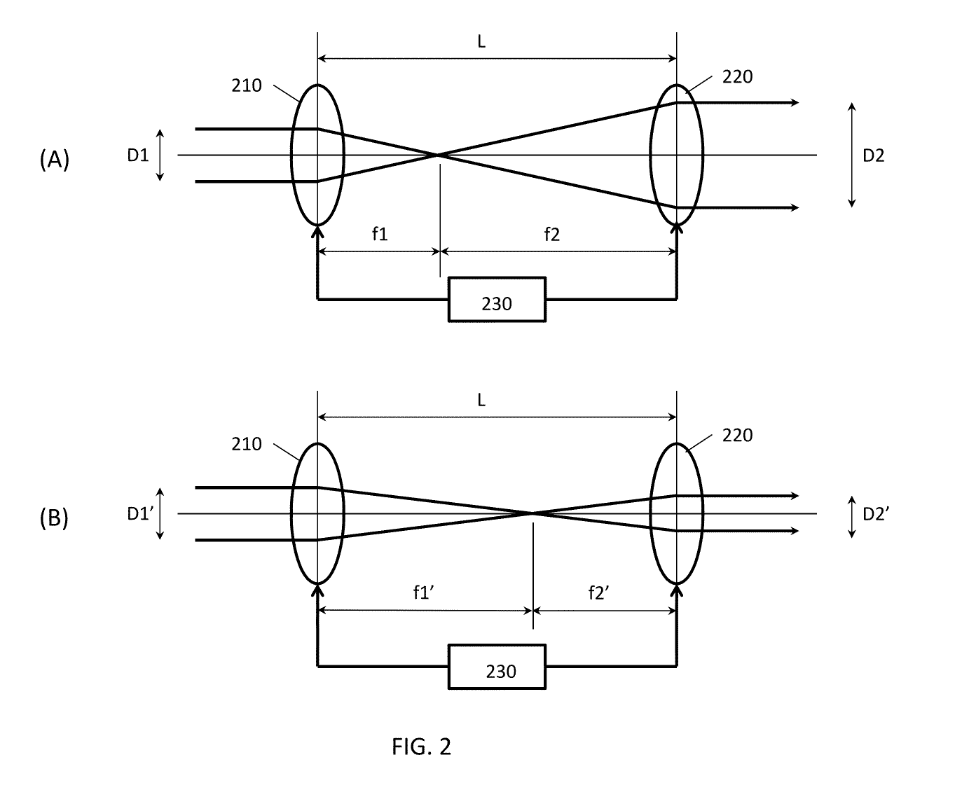

FIG. 2 shows a variable beam expander in accordance with an embodiment of the invention. Lens 210 and lens 220 are electrically tunable lenses and they are separated by a distance L. The focal lengths of the respective lenses 210 and 220 are electrically tuned by a control circuit 230. As shown in FIG. 2 (A), the lens 210 is controlled by the circuit 230 to have a focal length f1, and the lens 220 is controlled by the circuit 230 to have a focal length f1, such that the sum of the focal lengths is equal to the separation of the lenses, i.e., f1+f2=L. The expander power is given by M=D2/D1=f2/f1.

As shown in FIG. 2 (B), a different expander power M=D2′/D1′=f2′/f1′ is achieved when the control circuit 230 changes the focal length of lens 210 to a value f1′, the focal length of lens 220 to a value f2′ while maintaining the relationship that the sum of the focal lengths is equal to the separation of the lenses, i.e., f1′+f2′=L. Because the focal lengths are adjusted electrically and the distance between the lenses is fixed, the expander power M can be adjusted quickly and conveniently without the mechanical moving parts that plague the existing systems.

Note that although FIG. 2 only illustrates the case where both lenses 210 and 220 are positive (convex) lenses, the underlying principle also applies to the case where one of the lenses is a negative (concave) lens. As shown in FIG. 1 (B), the focal length f1 of the concave lens 130 has a negative value, by convention. Therefore, relationship f1+f2=L still applies, and the above formula for expander power, becomes M=D2/D1=|f2/f1|. Furthermore, the Galileo beam expanders typically have a shorter length L because of the negative focal length value in the equation f1+f2=L.

In one embodiment, the electrically tunable lenses have a tuning range of approximately from 45 mm to 120 mm, resulting in a continuous expander power range of approximately from 0.38 to 2.67. Other tunable ranges may be employed based on the specific needs of an application. Furthermore, in another embodiment, a fixed beam expander is added to the about variable beam expander arrangement. For example, a 2× beam expander will alter the above range to 0.76-5.34×.

There are many types of electrically tunable lenses that are used in certain embodiments of the invention. Non-limiting examples of electrically tunable lenses include liquid lenses, deformable lenses and liquid crystal (LC) lenses. Other types of electrically tunable lenses are contemplated.

LC lenses have the advantage of low cost, light weight, and no moving parts. The main mechanism of the electrically tunable focal length of the lenses results from the parabolic distribution of refractive indices due to the orientations of the LC directors (i.e., the average direction of the molecular axes). The incident light beam is then bent into a converging or a diverging light, which indicates the lensing effect for the incident light beam as a positive or a negative lens.

An electrically deformable lens typically consists of a container filled with an optical fluid and sealed off with an elastic polymer membrane. An electromagnetic actuator integrated into the lens controls a ring that exerts pressure on the container. The deflection of the lens depends on the pressure in the fluid; therefore, the focal length of the lens can be controlled by current flowing through the coil of the actuator.

In a liquid lens, the shape of the lens can be controlled by applying an electric field across a hydrophobic coating so that it becomes less hydrophobic—a process called electrowetting that resulted from an electrically induced change in surface tension. As a result, the aqueous solution begins to wet the sidewalls of the tube, altering the radius of curvature of the meniscus between the two fluids and thus the focal length of the lens.

Note that it is not necessary that both lenses are of the same type of electrically tunable lenses. For example, one lens is a LC lens and the other is an electrically deformable lens. Other combinations are also contemplated. Using different types of electrically tunable lenses is especially useful, when a large difference between f1 and f2 is needed to achieve a specific expander power.

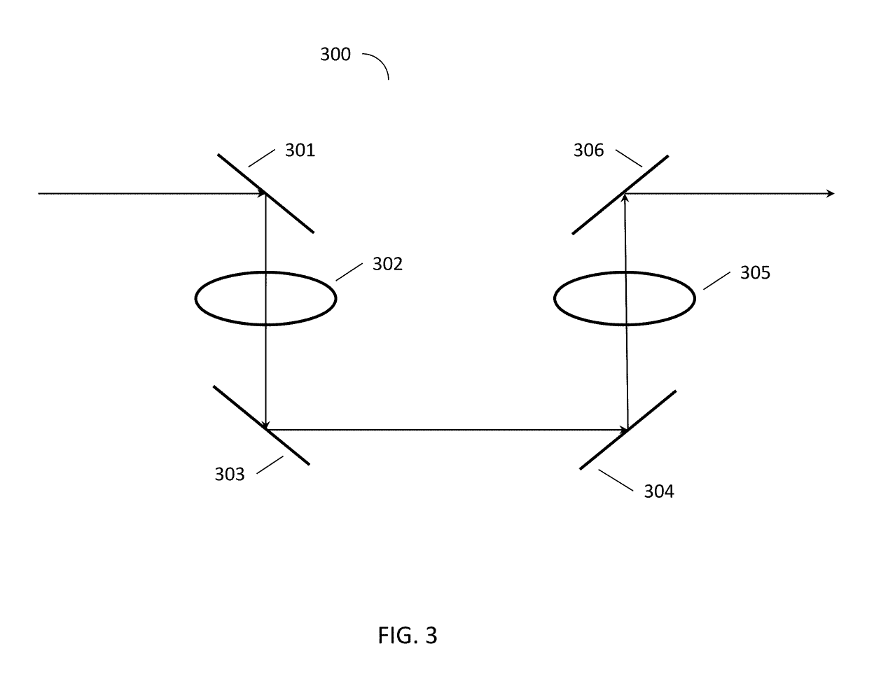

FIG. 3 shows a variable beam expander device 300 according to an embodiment. In embodiment, the optical axes of the lenses 302, 305 are vertical. This configuration provides an optimal operating condition for certain types of electrically deformable lenses. When a beam enters the variable beam expander 300, the mirror 301 reflects the beam to the vertical direction down towards the lens 302. After passing through the lens 302, the beam is reflected by the mirror 303 towards mirror 304. The mirror 304 reflects the beam to the vertical direction up towards the lens 305. After passing through the lens 305, the beam is reflected by the mirror 306 to the output direction.

As discussed above the control circuit controls the focal lengths of the lenses 302, 305, such that the sum of the focal lengths equals to the sum of the optical paths between lens 302 and mirror 303, between mirror 303 and mirror 304, and between mirror 305 and lens 305.

This configuration has a further advantage that the horizontal dimension of the device can be shortened due to the additional optical paths in the vertical direction.

In one embodiment, the device uses two electrically focus tunable lenses (for example, OPTOTUNE p/n: EL-30-LD) in a Keplerian configuration. The radius of curvature of the polymer based lens can be changed by applying a current to an electromagnetic actuator. The actuator changes the pressure inside the lens which is inversely proportional to the focal length.

In one embodiment, the lenses are horizontally mounted in a tightly tolerance bore. They are mounted horizontally due to the fact the polymer lens is filled with a liquid which is distorted by gravity, degrading the wavefront quality of the light. Mounting horizontally reduces this effect, providing close to diffraction limited performance. In one embodiment, four low drift mirror mounts and four silver mirrors are used to direct the beam through each lens.

In one embodiment, each lens is characterized by recording the focal length of the lens as a function of the current applied. The data is then interpolated to provide a continuous relationship between focal length and current over the range the actuator is designed to operate over (e.g., 0-300 mA).

In one embodiment, the variable beam expander device is modeled to give data on the relationship between the current needed in each lens for a given magnification at a given wavelength. To this end the radius of curvature on each lens is optimized for a range of magnifications (e.g., 0.5×-2.4× in increments of 0.01×). In one embodiment, an addition of a fixed beam expander before or after the device can adjust the range of magnifications achievable. In one embodiment, optimization is done for a range of different wavelengths (e.g., 680 nm-1600 nm in increments of 5 nm) to compensate for the effects of dispersion. The radius of curvature of each lens is converted into focal length which yields the appropriate current of each lens for a given magnification and wavelength. In one embodiment, this information is used by the control software in the form of a lookup table to provide smooth continuous adjustment of magnification at a range of wavelengths.

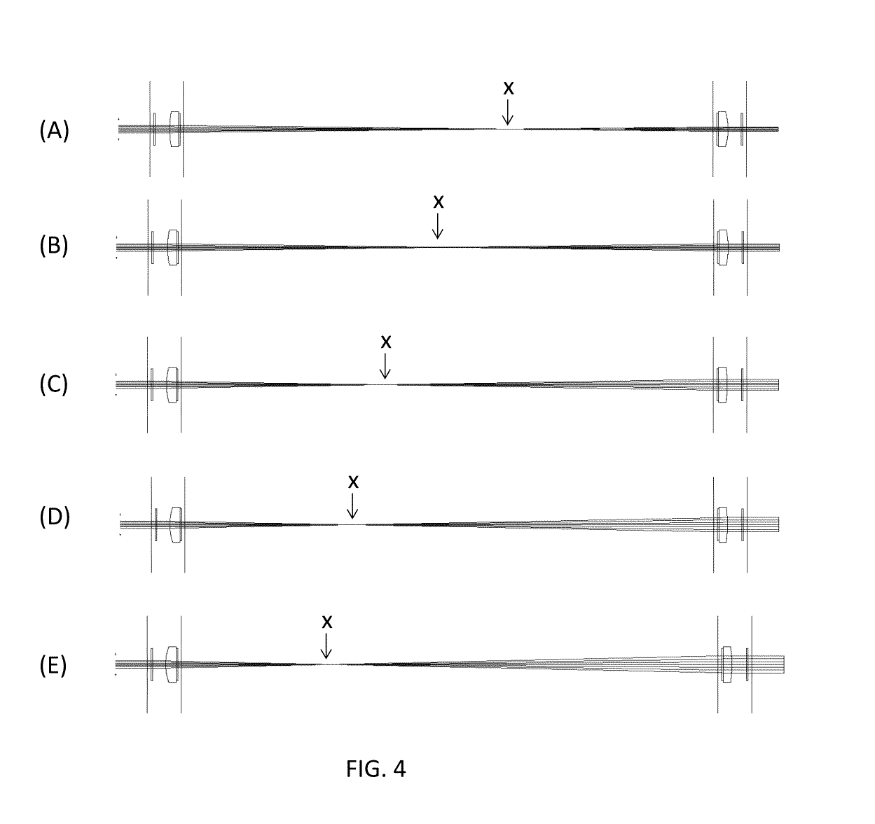

FIG. 4 shows how the variable beam expander expands and shrinks the beam size. As can be seen in (A) through (E), the location of the focal point X causes the resulting beam size to shrink or expand.

Note that the heat generated by the current across the actuator causes the volume of the liquid inside the polymer to expand. This causes the focal length to decrease which degrades system performance. In one embodiment, the resistance of the actuator is measured. Measuring the resistance of the actuator can act as a proxy for the temperature inside the lens. In one embodiment, using this resistance measurement information, adjustment is made to eliminate the error introduced by the buildup of heat. In another embodiment, the temperature is measured directly using a thermistor mounted on the actuator.

The device as described in one of the above embodiments is placed between a high power Ti:Sapphire laser and a two photon microscope. The device can perform the beam expansion/contraction as described above. In one embodiment, this the device can also change the focal plane of an objective. By doing so the device can selectively scan through a sample in z (A-Scan).

In normal operation the beam expander according to one embodiment provides collimated light to the back aperture of an objective. By varying the focal length of the second liquid lens the light entering the back aperture of the objective can either be collimated, diverging or converging. Through this mechanism the focal plane of the objective can be altered. Using the second liquid lens in this way will result in either under filling or overfilling the back aperture of the objective. This can be corrected using the first lens to change the overall magnification of the device to provide collimated, diverging or converging light that exactly fills the back aperture of the objective.

Note that in order to correct for incident beams that are not collimated, the condition of the sum of the first and second focal lengths is equal to the fixed distance between the first and second lenses in the variable beam expander needs to be modified. In one embodiment, the sum of the focal lengths will be slightly less than the distance between the lenses when correcting for a diverging beam. In another embodiment, the sum of the focal lengths will be slightly less than the distance between the lenses when correcting for a converging beam.

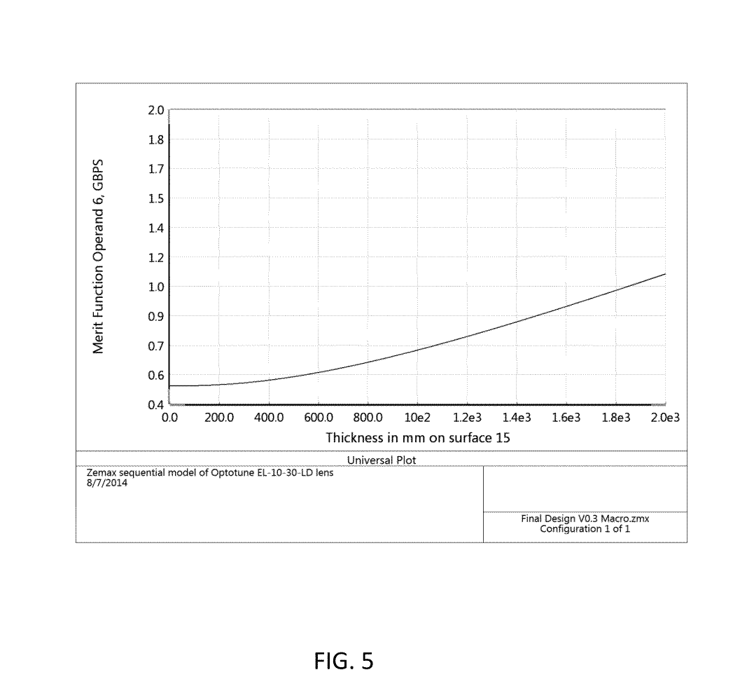

Furthermore, when the system is modelled to give the relationship between magnification and focal lengths the effects of diffraction are taken into consideration. FIG. 5 shows the beam radius (y-axis) as a function of distance from the exit aperture of the device (x-axis). Because of diffraction, the output beam will never be perfectly collimated over a long distance and will diverge as the beam propagates. According to an embodiment, the focal lengths of the lenses are adjusted, resulting in the effect of adjusting the position of the beam waist.

For example, the device is optimized for 0.5× and the beam waist is placed at the exit aperture of the device. Diffraction causes divergence as the beam propagates so in the far field the beam radius is much greater than the radius in the near field. To account for the diffraction, the above condition is adjusted. For example, lens 1 to lens 2 distance=166.87 mm, and f1+f2=120.985+53.96=174.945 mm.

In practice, the beam needs to be much closer to 0.5× over an extended range. To do this, in one embodiment, the system is optimized to place the beam waist in the middle of the desired working distance.

The system is able to compensate for this effect by placing the beam waist at a specific point which gives a pseudo-collimated beam over some desired working distance. This results in the sum of the focal lengths being slightly less than the distance between the lenses.

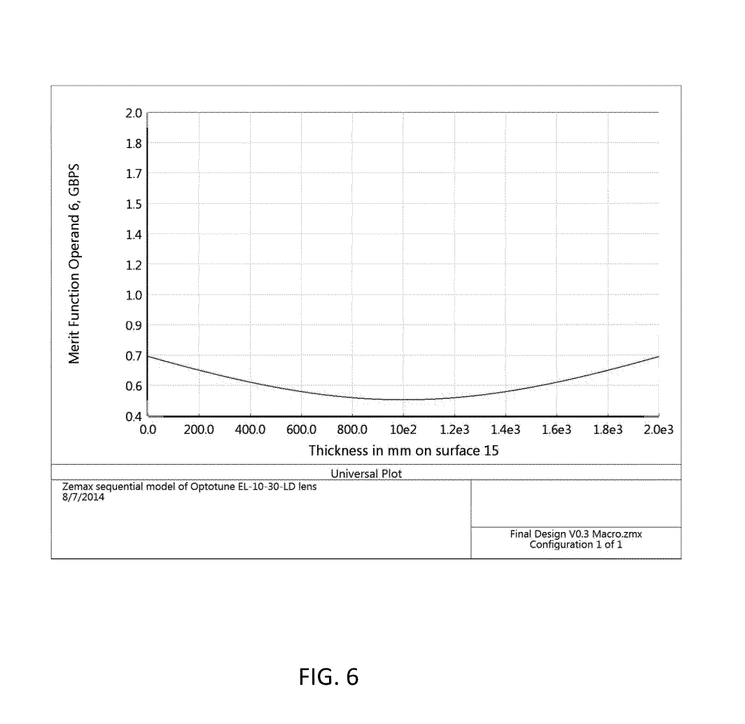

As shown in FIG. 6, the beam waist is at the lm mark and the beam diameter is much closer to 0.5× over the range we need. In this example, the condition is modified to: f1+f2=106.762+65.747=172.489 mm.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A variable beam expander, comprising:
a first lens having a first focal length that is adjustable by a control circuit;
a second lens having a second focal length that is adjustable by the control circuit;
wherein the first lens and the second lens are separated by a fixed distance; and
wherein the control circuit is configured to adjust the first and second focal lengths such that the sum of the first and second focal lengths is equal to the fixed distance.

2. The variable beam expander of claim 1, wherein the first and second lenses are convex lenses.

3. The variable beam expander of claim 1, wherein one of the first and second lenses is a concave lens and the other is a convex lens.

4. The variable beam expander of claim 1, wherein the first and second focal lengths are adjustable over a range of approximately 45 mm to 120 mm.

5. The variable beam expander of claim 1, wherein the variable beam expander has a continuous expander power range of approximately from 0.38 to 2.67.

6. The variable beam expander of claim 1, wherein the first and second lenses are liquid crystal lenses.

7. The variable beam expander of claim 1, wherein the first and second lenses are electrically deformable lenses.

8. The variable beam expander of claim 1, wherein the first and second lenses are liquid lenses.

9. The variable beam expander of claim 1, wherein the first and second lenses are of different types of electrically tunable lenses.

10. The variable beam expander of claim 1, further comprising a look-up table that contains a relationship between focal lengths of the electrically tunable lenses and electric currents applied to the lenses by the control circuit.

11. The variable beam expander of claim 10, wherein the relationship is adjusted based on heat generated by the applied electric currents.

12. The variable beam expander of claim 11, wherein the heat generated is inferred from resistance measurements of an actuator of the electrically tunable lenses.

13. The variable beam expander of claim 11, wherein the heat generated is measured by a thermistor mounted on an actuator of the electrically tunable lenses.

14. A variable beam expander, comprising:
a first lens having a first focal length that is adjustable by a control circuit, the optical axis of the first lens being in a first vertical direction;
a second lens having a second focal length that is adjustable by the control circuit, the optical axis of the second lens being in a second vertical direction;
a first mirror;
a second mirror;
a third mirror; and
a fourth mirror;
wherein the first mirror is configured to direct a beam coming from an input of the variable beam expander to pass through the first lens in the first vertical direction;
wherein the second mirror is configured to direct the beam that passes through the first lens to the third mirror;
wherein the third mirror is configured to direct the beam from the second mirror to pass through the second lens in the second vertical direction;
wherein the fourth mirror is configured to direct the beam that passes through the second lens to an output of the variable beam expander; and
wherein the control circuit is configured to adjust the first and second focal lengths such that the sum of the first and second focal lengths is equal to the sum of the paths from the first lens to the second mirror, from the second mirror to the third mirror, and from the third mirror to the second lens.

15. The variable beam expander of claim 14, wherein the first and second lenses are polymer lenses filled with a liquid.

16. A method of operating a variable beam expander that comprises a first lens having a first focal length that is adjustable by a control circuit; a second lens having a second focal length that is adjustable by the control circuit; wherein the first lens and the second lens are separated by a fixed distance, the method comprising:
adjusting the first and second focal lengths by the control circuit such that the sum of the first and second focal lengths is equal to the fixed distance.

17. The method of claim 16, further comprising:
varying the focal length of the first lens in order to change a focal plane of an objective lens; and
adjusting the focal length of the second lens to change the beam size to fill a desired portion of an aperture of the objective lens.

18. The method of claim 16, further comprising:
correcting a divergent or convergent incident beam by further adjusting the sum of the first and second focal lengths to be different than the fixed distance by an amount;
wherein the amount depends on a divergence or convergence of the incident beam.

19. The method of claim 16, further comprising:
correcting a diffraction effect of an aperture by further adjusting the sum of the first and second focal lengths to be different than the fixed distance by an amount;
wherein the amount depends on a desired location of a beam waist.
